(19) United States
(12) Patent Application Publication
(10) Pub. No.: US 2017/0351683 A1
(43) Pub. Date: Dec. 7, 2017

(54) HIERARCHICAL DATA INSERTION

(71) Applicant: salesforce.com, inc., San Francisco, CA (US)

(72) Inventors: Jay Hurst, San Francisco, CA (US); Abhinav Chadda, Emeryville, CA (US); Charles Fineman, Berkeley, CA (US); Zhi Li, Bothell, WA (US); Shreemanth Karthik Hosahalli, Mountain View, CA (US)

(21) Appl. No.: 15/175,361

(22) Filed: Jun. 7, 2016

(51) Int. Cl. G06F 17/30

(52) U.S. Cl. CPC G06F 17/3056; G06F 17/30365; G06F 17/30424

(57) ABSTRACT

Techniques are disclosed relating to insertion of objects into a database. In some embodiments, a client may programmatically define arbitrary relationships (such as hierarchical relationships) among different types of objects to be inserted into a database at a server. The objects may then be sent to the database, which may determine an insertion order that allows the desired relationships to be created. The insertion may then be committed, causing all the desired objects and relationships to be created in the database.

### BACKGROUND

### Technical Field

This disclosure relates to database transactions, and more particularly to efficient insertion of objects having a desired hierarchical relationship into a database.

### Description of the Related Art

In various situations, it may be desirable to add data (e.g., objects) to a database. For example, a client may wish to add data to a remote database stored at a server. In multi-tenant database embodiments (described in more detail below), a particular tenant may wish to insert large amounts of data into a multi-tenant database. The data to be inserted may have various types of structure, which may or may not have been anticipated by the owner or administrator of the database. For example, a tenant may wish to insert data with arbitrarily complicated hierarchical structures among the different types of data objects. It is desirable for such a tenant to be able to efficiently insert such data and have the hierarchical relationships respected in the inserted data.

With a multi-tenant system, tenants may have the advantage that they need not install software, maintain backups, move data to laptops to provide portability, etc. Rather, each tenant user need only be able to access the multi-tenant system to operate the applications and access that tenant's data. One such system usable for customer relationship management is the multi-tenant system accessible to salesforce.com subscribers. With such systems, a user need only have access to a user system with network connectivity, such as a desktop computer with Internet access and a browser or other HTTP client, or other suitable Internet client.

### BRIEF DESCRIPTION OF THE DRAWINGS

FIG. 1 is a block diagram illustrating an example environment for a multi-tenant database system, according to some embodiments.

FIG. 2 is a block diagram illustrating an example multi-tenant database system in more detail, according to some embodiments.

FIGS. 3A-3C and 4 are block diagrams illustrating examples of dependencies among object types, according to some embodiments.

FIG. 5 is a flow diagram according to one embodiment.

FIG. 6 is a block diagram illustrating an example computing system, according to some embodiments.

### DETAILED DESCRIPTION

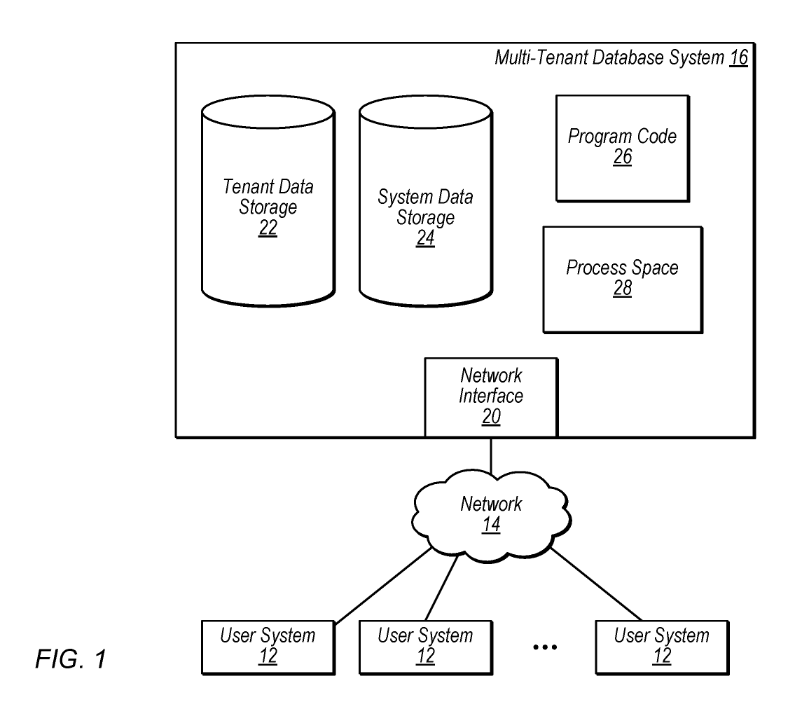

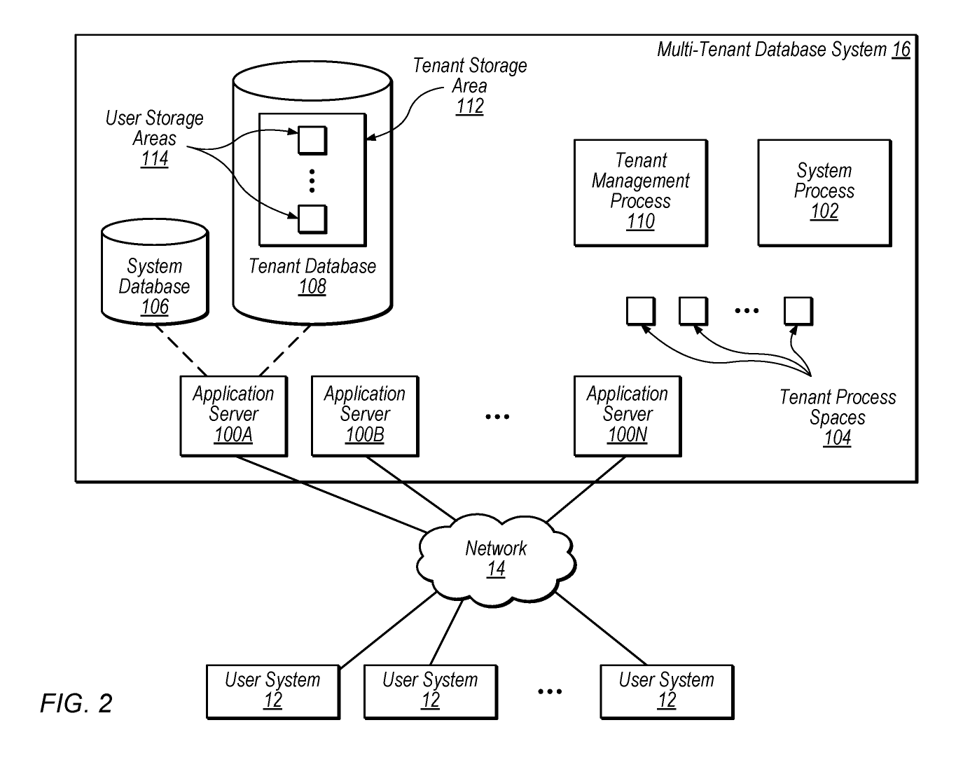

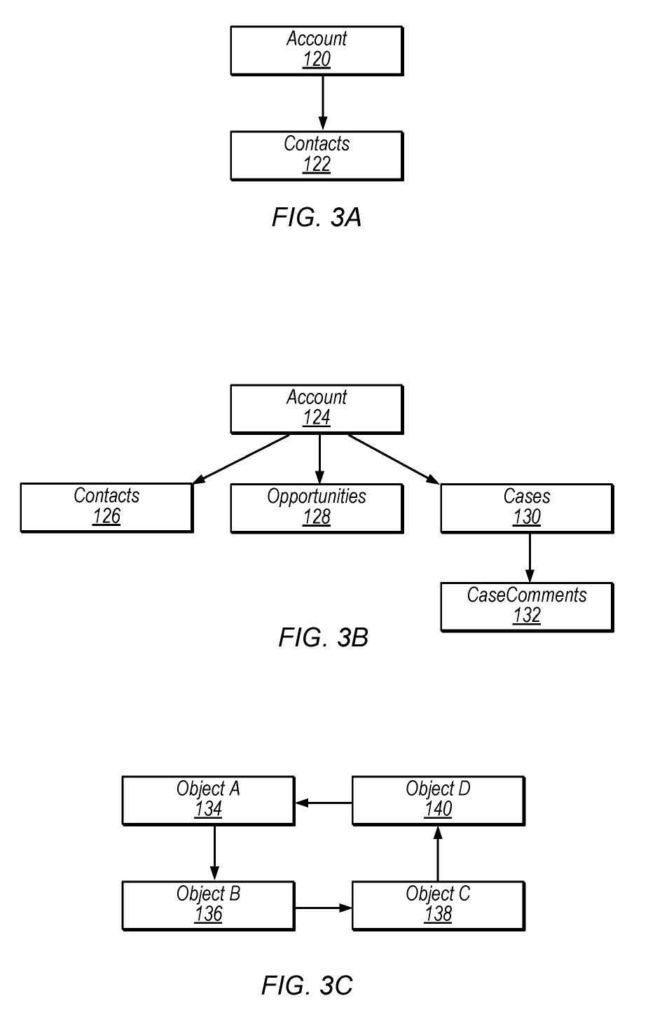

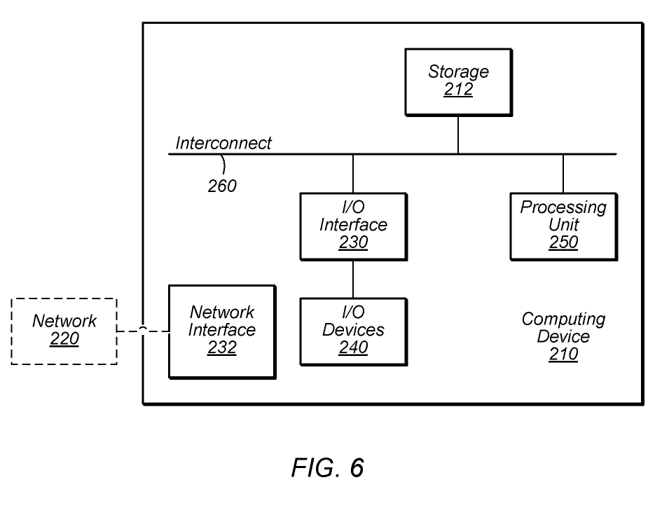

This disclosure initially describes, with reference to FIGS. 1 and 2, embodiments of an example multi-tenant database system. It then describes, with reference to FIGS. 3A-3C, 4, and 5, embodiments relating to insertion of objects in a database. Finally, an example computing system is shown at FIG. 6.

### Example Multi-Tenant Database Systems

FIG. 1 illustrates an example environment in which a multi-tenant database system might be implemented. Various embodiments of this disclosure will be described with reference to such a multi-tenant database system, but one of ordinary skill in the art with the benefit of this disclosure will understand various other types of systems to which this disclosure applies. As illustrated in FIG. 1 (and in more detail in FIG. 2) one or more user systems 12 may interact via a network 14 with a multi-tenant database system (MTS) 16. The users of those user systems 12 may be users in differing capacities, and the capacity of a particular user system 12 might be determined by the identity of the current user. For example, when a salesperson is using a particular user system 12 to interact with MTS 16, that user system 12 may have the capacities allotted to that salesperson. However, while an administrator is using the same user system 12 to interact with MTS 16, it has the capacities allotted to that administrator.

Network 14 may be a LAN (local area network), WAN (wide area network), wireless network, point-to-point network, star network, token ring network, hub network, or any other appropriate configuration. The Internet will be used in many of the examples herein and is one example of a TCP/IP (Transfer Control Protocol and Internet Protocol) network. It should be understood, however, that this disclosure may use any of various other types of networks.

User systems 12 may communicate with MTS 16 using TCP/IP and, at a higher network level, use other common Internet protocols to communicate, such as HTTP, FTP, AFS, WAP, etc. As an example, where HTTP is used, user system 12 might include an HTTP client commonly referred to as a browser for sending and receiving HTTP messages from an HTTP server at MTS 16. Such an HTTP server might be implemented as the sole network interface between MTS 16 and network 14, but other techniques might be used as well or instead. In some implementations, the interface between MTS 16 and network 14 includes load sharing functionality, such as round-robin HTTP request distributors to balance loads and distribute incoming HTTP requests evenly over a plurality of servers. Each of the plurality of servers may have access to the MTS's data, at least for the users that are accessing a server.

In some embodiments, the system shown in FIG. 1 implements a web-based customer relationship management (CRM) system. For example, in some embodiments, MTS 16 includes application servers configured to implement and execute CRM software applications as well as provide related data, code, forms, web pages and other information to and from user systems 12 and to store to, and retrieve from, a database system related data, objects and web page content. In embodiments of a multi-tenant system, tenant data may be arranged so that data of one tenant is kept separate from that of other tenants so that that one tenant does not have access to another tenant's data, unless such data is expressly shared.

One arrangement for elements of MTS 16 is shown in FIG. 1, including a network interface 20, storage 22 for tenant data, storage 24 for system data accessible to MTS 16 and possibly one or more tenants, program code 26 for implementing various functions of MTS 16, and a process space 28 for executing MTS system processes and tenant-specific processes, such as running applications as part of an application service.

Several elements in the system shown in FIG. 1 may include conventional, well-known elements that need not be explained in detail here. For example, each user system 12 may be a desktop personal computer, workstation, laptop, PDA, cell phone, or any WAP-enabled device or any other computing device capable of interfacing directly or indirectly to the Internet or other network connection. User system 12 may execute an HTTP client, e.g., a browsing program, such as Microsoft's Internet Explorer™ browser or another browser, or a WAP-enabled browser in the case of a cell phone, PDA or other wireless device, or the like, allowing a user (e.g., subscriber of a CRM system) of user system 12 to access, process, and view information and pages available to it from MTS 16 over network 14. In some instances, a user (e.g., a cell phone user) may execute a dedicated application that is configured to access MTS 16 instead of a general-purpose browser. Each user system 12 may include one or more user interface devices, such as a keyboard, a mouse, touch screen, pen or the like, for interacting with a graphical user interface (GUI) provided by the browser on a display monitor screen, LCD display, etc. in conjunction with pages, forms and other information provided by MTS 16 or other systems or servers. As discussed above, this disclosure is suitable for use with the Internet, which refers to a specific global internetwork of networks. It should be understood, however, that other networks may be used instead of the Internet, such as an intranet, an extranet, a virtual private network (VPN), a non-TCP/IP based network, any LAN or WAN or the like.

In some embodiments, each user system 12 and its components are operator-configurable using applications, such as a browser, that include computer code executable on one or more processing elements. Similarly, in some embodiments, MTS 16 (and additional instances of MTSs, where more than one is present) and their components are operator configurable using application(s) that include computer code executable on one or more processing elements. Thus, various operations described herein may be performed by executing program instructions stored on an article of manufacture including a non-transitory computer-readable medium and executed by one or more processing elements. The program instructions may be stored on a non-volatile medium such as a hard disk, or may be stored in any other volatile or non-volatile memory medium or device as is well known, such as a ROM or RAM, or provided on any media capable of staring program code, such as a compact disk (CD) medium, digital versatile disk (DVD) medium, a floppy disk, and the like. Additionally, the entire program code, or portions thereof, may be transmitted and downloaded from a software source, e.g., over the Internet, or from another server, as is well known, or transmitted over any other conventional network connection as is well known (e.g., extranet, VPN, LAN, etc.) using any communication medium and protocols (e.g., TCP/IP, HTTP, HTTPS, Ethernet, etc.) as are well known. It will also be appreciated that computer code for implementing aspects of the present disclosure can be implemented in any programming language that can be executed on a server or server system such as, for example, in C, C++, HTML, Java, JavaScript, or any other language.

According to one embodiment, MTS 16 is configured to provide web pages, forms, applications, data, and/or media content to user systems 12 to support the access by user systems 12 as tenants of MTS 16. As such, in this embodiment, MTS 16 provides security mechanisms to keep each tenant's data separate unless the data is intentionally shared. If more than one MTS is used, they may be located in close proximity to one another (e.g., in a server farm located in a single building or campus), or they may be distributed at locations remote from one another (e.g., one or more servers located in city A and one or more servers located in city B). As used herein, MTSs may include one or more logically and/or physically connected servers distributed locally or across one or more geographic locations. Additionally, the term “server” includes a computer system, including processing hardware and process space(s), and an associated storage system and database application as is well known in the art. It should also be understood that “server system” and “server” are often used interchangeably herein. Similarly, the databases described herein can be implemented as single databases, a distributed database, a collection of distributed databases, a database with redundant online or offline backups or other redundancies, etc., and might include a distributed database or storage network and associated processing intelligence.

FIG. 2 illustrates another example embodiment of MTS 16 and various interconnections in more detail. In this example, the network interface is implemented as one or more HTTP application servers 100. Also shown is system process space 102 including individual tenant process spaces 104, a system database 106, tenant database(s) 108 and a tenant management process space 110. Tenant database 108 might be divided into individual tenant storage areas 112, which can be either a physical arrangement or a logical arrangement. Within each tenant storage area 112, user storage 114 might be allocated for each user.

It should also be understood that each application server 100 may be communicatively coupled to database systems, e.g., system database 106 and tenant database(s) 108, via a different network connection. For example, one server 100X might be coupled via the Internet, another server 100Y might be coupled via a direct network link, and another server 100Z might be coupled by yet a different network connection. TCP/IP is one protocol for communicating between application servers 100 and the database system; however, it will be apparent to one skilled in the art that other transport protocols may be used to optimize the system depending on the network interconnect used.

In some aspects, each application server 100 is configured to handle requests for any user/organization. Because it is desirable to be able to add and remove application servers from the server pool at any time for any reason, there may be in some cases be no server affinity for a user and/or organization to a specific application server 100. In one embodiment, therefore, an interface system (not shown) implementing a load balancing function (e.g., an F5 Big-IP load balancer) is communicatively coupled between application servers 100 and user systems 12 to distribute requests to application servers 100. In one aspect, the load balancer uses a least connections algorithm to route user requests to application servers 100. Other examples of load balancing algorithms, such as round robin and observed response time, also can be used. For example, in certain aspects, three consecutive requests from the same user could be routed to three different servers, and three requests from different users could be routed to the same server. In this manner, MTS 16 is multi-tenant, wherein MTS 16 handles storage of different objects and data across disparate users and organizations.

As an example of storage, one tenant might be a company that employs a sales force where each salesperson uses MTS 16 to manage their sales process. Thus, a user might maintain contact data, leads data customer follow-up data, performance data, goals and progress data, all applicable to that user's personal sales process (e.g., in tenant database 108). In some MTS embodiments, since all of this data and the applications to access, view, modify, report, transmit, calculate, eta, can be maintained and accessed by a user system having nothing more than network access, the user can manage his or her sales efforts and cycles from any of many different user systems.

While each user's sales data may be separate from other users' sales data regardless of the employers of each user, some data may be organization-wide data shared or accessible by a plurality or all of the staff for a given organization that is a tenant. Thus, there may be some data structures managed by MTS 16 that are managed at the tenant level while other data structures are managed at the user level. Because an MTS may support multiple tenants including possible competitors, the MTS should have security protocols that keep data, applications and application use separate. Also, because many tenants will opt for access to an MTS rather than maintain their own system, security, redundancy, up-time, and backup are desirable functions that may be implemented in the MTS.

In addition to user-specific data and tenant-specific data, MTS 16 might also maintain system level data usable by multiple tenants. Such system level data might include industry reports, news, postings, and the like that are sharable among tenants.

In certain aspects, user systems 12 communicate with application servers 100 to request and update system-level and tenant-level data from MTS 16 that may require one or more queries to system database 106 and/or tenant database 108. In some embodiments, MTS 16 automatically generates one or more SQL statements (the SQL query) designed to access the desired information.

Each database may generally be viewed as a set of logical tables containing data fitted into predefined categories. Each table typically contains one or more data categories logically arranged in physical columns. Each row of a table typically contains an instance of data for each category defined by the columns. For example, a CRM database may include a table that describes a customer with columns for basic contact information such as name, address, phone number, fax number, etc. Another table may describe a purchase order, including columns for information such as customer, product, sale price, date, etc.

### EXAMPLE EMBODIMENTS

As noted above, it may be desirable in some situations to insert large quantities of structured or hierarchical data into a database. For example, such hierarchical data could be exported from a different database, serialized from a running program, manually generated, or in general derived from any of a variety of sources. One example of a use case for inserting hierarchical data might include a user who desires to fill out a form on a single page with data that needs to be stored in different (but perhaps related) entities within a multi-tenant database system. A more complex use case might include an integration in which hierarchical data from some existing system needs to be integrated or periodically synced into a database system.

Current systems for inserting hierarchical data into a database typically suffer from various drawbacks. In particular, many such systems do not have an efficient way of programmatically inserting data that has arbitrarily complicated hierarchical relationships into a database, unless that database already “understands” such relationships. In such a system, it may thus be necessary to first create an object hierarchy at the database before inserting the data, typically requiring a large number of application programming interface (API) calls and database round trips. Further, sometimes data insertions may fail or cause an error; existing solutions may require the user to manually roll back the remainder of the insertion (e.g., the objects that have already been inserted). Manual management of rollbacks is often a source of errors.

Various techniques are disclosed for inserting structured data in multi-tenant systems as well as other types of systems. According to some embodiments of this disclosure, a client can programmatically insert all related objects in a single round trip to the database. In some embodiments, arbitrary new types of objects, as well as arbitrarily complicated relationships between objects, can be defined in any desired way by the client. For example, such relationships may be defined using a “meta-model” that allows flexibility in data modeling. Once the insertion has been requested, the server may determine how best to order the creation of the object types and linkages in the database. If there are no errors, the entire insertion may be committed in one transaction. Alternatively, if one or more errors are detected, the insertion may be rolled back.

According to some embodiments of this disclosure, rather than making multiple insertion calls to the database's API, the data may be inserted into the database as part of a single payload, and the inserted data may respect the desired hierarchical relationships. That is, hierarchical data may be inserted in a single transaction (or a small number of transactions) without a previously established data model. In some instances, a data management API is used to insert data. For purposes of this disclosure, however, no distinction is made between a database API itself and a data management API that is usable to create or insert data in a database.

Turning now to FIG. 3A, an embodiment of a relatively simple object hierarchy is shown. In some embodiments of this disclosure, various types of built-in database object types, relationships, and fields may be used. In some embodiments, other custom database object types, relationships, and fields may also be used (either in conjunction with, or in place of, the built-in structures). For example, some embodiments may operate with built-in database object types including Account objects (typically representative of business entities), Contact objects (typically representative of a person with whom a business relationship exists), Lead objects (typically representative of a person with whom a business relationship does not yet exist), Opportunity objects (typically representative of a sales event), etc. Such built-in objects may have standard types of relationships (e.g., a Contact may be a child of an Account, etc.) and fields (e.g., a Contact may have fields such as Email, Home Phone, etc.). Going beyond such built-in structures, any type of custom objects, relationships, and fields may be defined by a user.

In the embodiment of FIG. 3A, Account 120 is the top-level object (the parent), and Contacts 122 is a child object. An example of a representation for Account 120 that might be used to insert hierarchical data for Account 120 according to such a data hierarchy is as follows:

{
″Name″: ″example.com″,
″BillingCity″: ″San Francisco″,
″Contacts″: {″records″: [{...}]
}

As shown, this representation allows the insertion of a list of records as the Contacts that are to be associated with Account 120.

By transmitting such a representation to the database, a user may cause the database to create the object hierarchy and insert whatever data the user supplies. As shown in FIG. 3A and described in the above representation, Contacts 122 is a child of Account 120 and includes a list of records. Although this example is shown in JavaScript Object Notation (JSON), one of ordinary skill in the art with the benefit of this disclosure will understand that various other representations may also be used. For example, data may be specified in XML/SOAP, CSV, or any other suitable notation. Any such representation may be considered an example of user-specified code that specifies the relationships. For the sake of brevity, this disclosure will typically use JSON notation throughout.

Turning now to FIG. 3B, an example of a somewhat more complicated object hierarchy is shown. In FIG. 3B, Account 124 is the top-level object (the parent), and Contacts 126, Opportunities 128, and Cases 130 are all child objects. Further, CaseComments 132 is a child of Cases 130 (and thus a grandchild of Account 124).

An example of a representation for Account 124 that might be used to create such a data hierarchy is as follows:

```
{
″Name″: ″example.com″,
″BillingCity″: ″San Francisco″,
″Contacts″: {″records″: [{...}],
″Opportunities″: {″records″: [{...}]},
″Cases″: {″records″: [{
  ″Subject″:″Example text″,
  ″CaseComments″ : {″records″: [{...}]
}]}
}
```

In general, object hierarchies such as those shown in FIGS. 3A and 3B may be considered in terms of graph theory as directed graphs (digraphs), wherein each object is a vertex, and each parent/child relationship is a directed edge. As can be seen, the hierarchies in FIGS. 3A and 3B each form a tree structure, which means that each pair of vertices is connected by exactly one path—that is, there are no graph cycles.

As is known from graph theory, tree structures admit of a topological sorting. A topological sorting is an ordering of a tree's vertices such that for every directed edge uv from vertex u to vertex v, u should come before v in the topologically sorted ordering of the vertices. So, for example, a topological sorting of the tree shown in FIG. 3B might be: {Account 124, Contacts 126, Opportunities 128, Cases 130, CaseComments 132}. As can be seen, every object in the topological sorting comes before its descendants (children, grandchildren, etc.). When such a topologically sorted list of vertices is possible, it may then be used by the database to instantiate the data. That is, it may be desirable to instantiate parent objects before their children, etc.

Turning now to FIG. 3C, an embodiment of a potential data hierarchy is shown. In this example, however, a cyclic dependency is present. That is, although the potential data hierarchy of FIG. 3C is a directed graph, it does not form a tree structure, and thus it does not admit of a topological sorting. There is no ordering of Object A 134, Object B 136, Object C 138, and Object D 140 such that each object comes before all of its descendants in the ordering.

As will be understood by one of ordinary skill in the art with the benefit of this disclosure, inserting structured data that does not form a tree structure into a database may present various problems. Accordingly, in some embodiments, it may be desirable to simply raise an error if a client attempts to insert the objects of FIG. 3C (or any other data structure that includes one or more cyclic dependencies) into the database.

One of ordinary skill in the art with the benefit of this disclosure will further understand that it may sometimes be desirable to insert data having arbitrarily complicated hierarchical structures into a database. According to some embodiments of this disclosure, it may be possible to do so efficiently regardless of how complicated the hierarchy may be.

According to one embodiment, a client may transmit user-specified code that creates an object hierarchy and inserts the desired objects in a single round trip (e.g., a single round trip between the client and an application server). In another embodiment, a client may first send a request to create an Account (for example), and the database may generate an account ID; the client may then insert the data with a reference to this account ID from all of the related objects to be created, for a total of two round-trips.

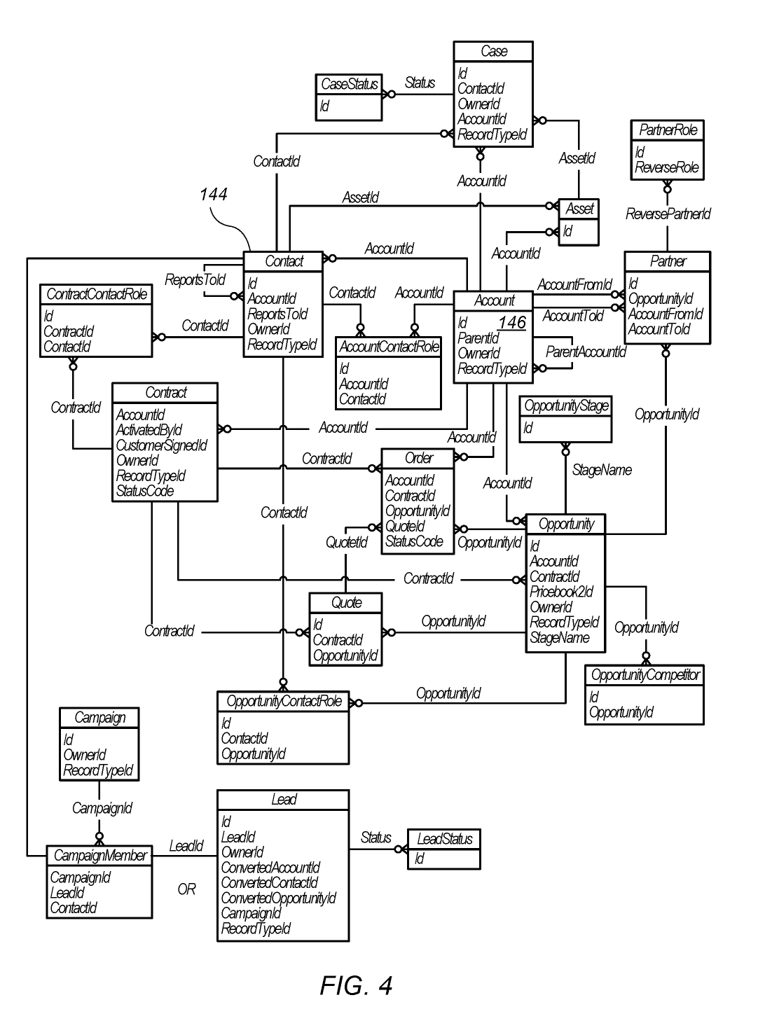

Turning now to FIG. 4, a more complicated data hierarchy structure is shown. The data hierarchy of FIG. 4 need not be discussed in all of its details; for the sake of brevity, it is sufficient to note that the Contact 144 object has a foreign key to Account 146 (that is, a field that uniquely identifies the relationship to Account 146). This creates a relationship in which Contacts is a child of Account 146. For such a relationship, a user might insert data in the following way:

```
{
″records″ : [{
  ″attributes″ : {″type″ : ″Account″, ″referenceId″ : ″reference1″},
  ″Name″ : ″example.com″,
  ″Contacts″ : {
    ″records″ : [{ .. }]
  }
}]
}
```

For the sake of context, a small amount of background information about relationships may be useful. In general, a relationship name may be given to each relationship such as the relationship between Account 146 and Contact 144. The form of the name may be different, depending on the direction of the relationship. For example, for child-to-parent relationships, the relationship name in the child that references the parent may be the name of the foreign key, and a relationshipName property may hold the reference to the parent object. For example, the Contact child object has a child-to-parent relationship to the Account object, so the value of relationshipName in the Contact object is “Account”. Relationships may be traversed by specifying the parent using dot notation in a query, for example “SELECT Contact.FirstName, Contact.Account.Name from Contact”. Such a query may return the first names of all the contacts in the organization, and for each contact, the Account name that is the parent of that contact.

For parent-to-child relationships, the parent object may have a name for the child relationship that is unique to the parent, such as the pluralized version of the child object name. For example, Account may have a child relationship to Contacts, and the relationshipName may be “Contacts”. Account may have other child relationships (e.g., Opportunities, Cases, etc.) with a corresponding relationshipName for each (e.g., Opportunities, Cases, etc.). These relationships may be traversed in the SELECT clause, using a nested SQL or SOQL query. For example: “SELECT Account.Name, (SELECT Contact.FirstName, Contact.LastName FROM Account. Contacts) FROM Account”. This query may return all Accounts, and for each Account, the first and last name of each Contact that is a child of that Account.

With the above discussion in mind, various other examples of the types of syntax that may be used to insert data will be apparent to one of ordinary skill in the art with the benefit of this disclosure. For example, another embodiment of data to be inserted might read as follows:

```
POST: /services/data/v34.0/composite/tree/GrandParent_c
″records″ : [{
  ″attributes″ : { ″type″ : ″GrandParent_c″, ″referenceId″:″localRef1″ },
  ″Name″ : ″GrandParent4″,
  ″City″ : ″San Francisco″,
  ″Parents_r″ : {
    ″records″ : [{
        ″attributes″ : { ″type″ : ″Parent_c″, ″referenceId″:″localRef2″},
        ″Name″ : ″Parent4″,
        ″Major″ : ″Clinical Research″,
        ″Children_r″ : {
          ″records″ : [{
              ″attributes″ : { ″type″ : ″Child_c″, ″referenceId″:
              ″localRef3″ },
              ″Name″ : ″child4″,
              ″Grandchildren_r″ : {
                  ″records″ : [{
                      ″attributes″: { ″type″ : ″grandchild_c″,
                      ″referenceId″:″localRef4″ },
                      ″Name″ : ″grandchild41″
                    },
                    {
                      ″attributes″ : { ″type″ : ″grandchild_c″,
                      ″referenceId″:″localRef5″ },
                      ″Name″ : ″grandchild42″
                    },
                    {
                      ″attributes″ : { ″type″ : ″grandchild_c″ ,
                      ″referenceId″:″localRef6″},
                      ″Name″ : ″grandchild43″
                    }
                  ]}
            }
          ]}
      }
    ]}
}]
```

Yet one more example of data to be inserted might read as follows:

```
POST: /services/data/v34.0/composite/tree/Account
{
  ″records″ :[{
    ″attributes″ : {″type″:″Account″, ″referenceId″ : ″ref1″},
    ″name″ : ″Account1″,
    ″phone″ : ″1234567890″,
    ″website″ : ″www.example.com″,
    ″NumberOfEmployees″ : ″100″,
    ″Type″ : ″Analyst″,
    ″Industry″ : ″Banking″,
    ″Contacts″ : {
      ″records″ : [{
          ″attributes″ : {″type″:″Contact″, ″referenceId″ : ″ref2″},
          ″lastname″ : ″John Doe″,
          ″Title″ : ″Member of Imaginary Names″,
          ″email″ : ″jdoe@example.com″
        },{
          ″attributes″ : {″type″:″Contact″, ″referenceId″ : ″ref3″},
          ″lastname″:″Jane Doe″,
          ″Title″ : ″Developer″,
          ″email″ : ″janedoe@example.com″
        },{
          ″attributes″ : {″type″:″Contact″, ″referenceId″ : ″ref4″},
          ″lastname″:″Homer Simpson″,
          ″Title″ : ″Nuclear engineer″,
          ″email″ : ″homer@example.com″
        },{
          ″attributes″ : {″type″:″Contact″, ″referenceId″ : ″ref5″},
          ″lastname″:″Agent Smith″,
          ″Title″ : ″Agent (duh)″,
          ″email″ : ″agentSmith@example.com″
        }]
    }
  }, {
    ″attributes″ : {″type″:″Account″, ″referenceId″ : ″ref6″},
    ″name″ : ″Example Inc.″,
    ″phone″ : ″1234567890″,
    ″website″ : ″www.example.com″,
    ″NumberOfEmployees″ : ″52000″,
    ″Type″ : ″Analyst″,
    ″Industry″ : ″Banking″,
    ″childAccounts″ : {
      ″records″ : [{
        ″attributes″ : {″type″:″Account″, ″referenceId″ : ″ref7″},
        ″name″ : ″Example Subsidiary″,
        ″phone″ : ″1234567890″,
        ″website″ : ″www.sub.example.com″,
        ″NumberOfEmployees″ : ″100″,
        ″Type″ : ″Analyst″,
        ″Industry″ : ″Banking″
      }]
    },
    ″Contacts″ : {
      ″records″ : [{
        ″attributes″ : {″type″:″Contact″, ″referenceId″ : ″ref8″},
        ″lastname″ : ″James Doe″,
        ″title″ : ″Janitor″,
        ″email″ : ″jamesdoe@example.com″
      }]
    }
  }]
}
```

The above examples show two potential hierarchies, each displaying certain aspects. The first of the two examples shows a hierarchy of a single top-level grandparent record along with single Parent, single Child, and multiple Grandchild records. This example may be considered a relatively linear tree. The second of the two examples shows a more complex tree with multiple top level Account records which contain different child relationships and records. The complexity of the relationships and the appropriate data manipulation (DML) execution order may be managed at the database, using the defined relationships in the meta-model, and the attributes defined in the request (e.g., the object type and referenceId). As demonstrated in these two examples, hierarchical trees of varying complexity can be defined and delivered using the same pattern

The above examples may each be considered to be user-specified code that defines the desired relationships for the data to be inserted. Various other types of user-specified code may also be envisioned by one of ordinary skill in the art with the benefit of this disclosure, and this disclosure should not be limited to any particular type of user specified code. Some embodiments of user-specified code may include executable program code in a selected programming language. Other embodiments of user-specified code may not be executable, but may be written in a language that is usable to define object relationships in any desired manner.

According to some embodiments of this disclosure, a user may use user-specified code to insert data through the use of a metadata model or “meta-model” which may be accessed via a metadata API. For example, such a metadata API may be exposed via a SOAP-based Web service, a REST API, etc. A meta-model may allow for flexibility in specifying a data model for the hierarchical data to be inserted into the database. Some embodiments related to such a metadata model are described in U.S. Pat. No. 9,098,365, which is hereby incorporated by reference in its entirety. A metadata API may in some embodiments expose two sets of methods. The first may allow the creation, deletion, and updating of sets of metadata components; for example, such methods may be used to modify the schema of a database object to include an additional field. The second set of methods may contain file-based metadata calls that allow the retrieval and deployment of file representations of metadata.

In general, metadata may be associated with various objects stored in a database and/or applications that are configured to run from a database, such as a multi-tenant database as described above. Metadata may define the name, default values, labels and type of each field, validation rules for data entry, business logic, etc. For example, a client may define a workflow rule to add functionality to an application based on the metadata that defines it. Metadata may also be used to configure and shape the default functionality of applications.

The metadata API may generally be used to retrieve, deploy, create, update or delete customization information, such as custom object definitions and page layouts. For example, the metadata API may also be used to manage setup and customization metadata such as by exporting customizations as XML metadata files, migrating configuration changes between organizations, modifying existing customizations using XML metadata files, managing customizations programmatically, etc.

Such metadata typically describes things like the type of object (e.g., standard objects, custom objects, external objects, etc.), the fields on the object, the data types of the fields, the various property of each field (e.g., external, lookup, master-detail, etc.), and/or any other desired properties. When a client creates objects and relates multiple objects using relationship fields on them, that information may be leveraged according to the present disclosure to dynamically parse the input representation and create the relations between the records being inserted, and then insert them according to their hierarchy. For example, as described above, such insertions may be done based on a topological sort of the types of objects in the hierarchy.

In general, user-specified code may be used to define the data model for the objects that are being inserted into the database. The meta-model described above is one example of a system that accepts user-specified code. Any type of API provided by the database system that allows user-specified code to express arbitrary hierarchical relationships may be used for this purpose. In some cases, such relationships may be inferred from the data model. For example, an API may be defined such that the validation and processing of the payload sent through the API is driven by the metamodel.

Once the database system has received user-specified code that indicates the hierarchical structure of objects that should be inserted, it may determine an insertion order. In one embodiment, the database system may perform a topological sort on the entities given in the input to create an execution order for them that instantiates parent objects before their child objects. The execution order may be implemented as a linked list of operations at each node. The operations of insertion may either be added to a node, or a new node may be created for a given operation. This may be governed by a set of rules, such as the following example rule set:

1) The execution order is queried to find the parent of the current entity.
a) If a parent is found, beginning at that location, search for the “best” node for that entity, wherein the best node is defined as a node where the current entity has no known parents.
b) If a parent is not found, query to see if the current node is capable of performing bulk operations with the current entity, wherein the bulk operation is defined by identical entity type.
   i. If yes, add it to the list of entities in the current node.
   ii. If no, move on to the next node and repeat b)

With a rule set such as the example rule set above, each entity may find a place in the execution order. Once that place is determined, the entities may be inserted in each node of the linked list (e.g., as a preliminary insertion without committing the operation). After inserting the entities, the child nodes may be linked with the IDs of the parents already inserted before inserting the children.

Once all of the entities have been inserted successfully, the operation may be committed. Once the insertion operation is committed, various other operations may be executed. For example, workflows and/or triggers may be executed on the inserted data (e.g., in the order of insertion). Workflows and triggers may include various programmatic actions to be taken on data. For example, a workflow might be defined to send an email when a certain object reaches a target state, or a trigger might be defined to determine whether a certain object has reached a target state, and then convert it to a different type of object once the target state has been reached.

If any failure occurs in the preliminary insertion, the entire transaction may be rolled back, and an error may be reported to the user. During the entire insertion process, a “referenceId” provided by the client may be used as means of relating a record to be created with the record that is actually created. Further, the referenceId may in some cases be used to associate a specific failure with a specific record—even when that record has not actually been created (e.g., due to the failure itself).

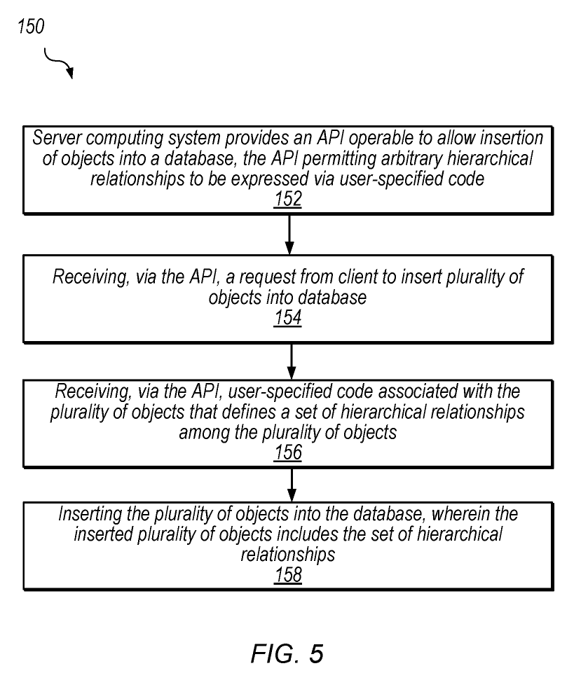

Turning now to FIG. 5, an example of a process 150 for inserting hierarchical data into a database is shown. The process begins at step 152.

At step 152, a server computing system that hosts a database provides an API to allow insertion of objects into the database. The database may in some embodiments be a multi-tenant database. The API provided by the server permits the expression of arbitrarily complicated hierarchical relationships among object types via user-specified code. As one example, the API might be configured to allow a client to express such relationships in JSON notation (or any other suitable notation) via a metadata model as described above. Flow proceeds to step 154.

At step 154, the server computing system receives, via the API, a request from a client to insert a plurality of objects into the database. Flow proceeds to step 156.

At step 156, the server computing system receives, via the API, user-specified code associated with the plurality of objects that defines a set of hierarchical relationships (e.g., child, parent, etc.) among those objects. The user-specified code may be executable code, or it may be code that is not executable but specifies the desired relationships. In some embodiments, the request of step 156 and the request of step 154 may be embodied as a single request; in other embodiments, they may be embodied as separate requests. Flow proceeds to step 158.

At step 158, the server computing system inserts the plurality of objects into the database as requested. The inserted objects include the set of hierarchical relationships specified at step 156. In some embodiments, the server computing system may determine an insertion order based on a topological sorting of the objects and relationships. In some embodiments, the server computing system may preliminarily insert the objects, but retain the ability to roll back the insertion of an error is detected, an exception thrown, an assertion raised, etc. After the insertion, the server computing system may provide a reference to the client that allows the client to access the inserted data. Flow ends at step 158.

### Example Computing System

Various operations described herein may be implemented by a computing device configured to execute program instructions that specify the operations. Similarly, various operations may be performed by circuitry designed or configured to perform the operations. In some embodiments, a non-transitory computer-readable medium has program instructions stored thereon that are capable of causing various operations described herein. As used herein, the term “processor” or “processing element” refers to various elements or combinations of elements configured to execute program instructions. Processing elements include, for example, circuits such as an ASIC (Application Specific Integrated Circuit), portions or circuits of individual processor cores, entire processor cores, individual processors, programmable hardware devices such as a field programmable gate array (FPGA), and/or larger portions of systems that include multiple processors, as well as any combinations thereof.

Turning now to FIG. 6, a block diagram of a computing device (which may also be referred to as a computing system) 210 is depicted, according to some embodiments. Computing device 210 may be used to implement various portions of this disclosure. Computing device 210 is one example of a device that may be used as a mobile device, a server computing system, a client computing system, or any other computing system implementing portions of this disclosure.

Computing device 210 may be any suitable type of device, including, but not limited to, a personal computer system, desktop computer, laptop or notebook computer, mobile phone, mainframe computer system, web server, workstation, or network computer. As shown, computing device 210 includes processing unit 250, storage subsystem 212, input/output (I/O) interface 230 coupled via interconnect 260 (e.g., a system bus). I/O interface 230 may be coupled to one or more I/O devices 240. Computing device 210 further includes network interface 232, which may be coupled to network 220 for communications with, for example, other computing devices.

As described above, processing unit 250 includes one or more processors. In some embodiments, processing unit 250 includes one or more coprocessor units. In some embodiments, multiple instances of processing unit 250 may be coupled to interconnect 260. Processing unit 250 (or each processor within processing unit 250) may contain a cache or other form of on-board memory. In some embodiments, processing unit 250 may be implemented as a general-purpose processing unit, and in other embodiments it may be implemented as a special purpose processing unit (e.g., an ASIC). In general, computing device 210 is not limited to any particular type of processing unit or processor subsystem.

As used herein, the terms “processing unit” or “processing element” refer to circuitry configured to perform operations or to a memory having program instructions stored therein that are executable by one or more processors to perform operations. Accordingly, a processing unit may be implemented as a hardware circuit implemented in a variety of ways. The hardware circuit may include, for example, custom very-large-scale integration (VLSI) circuits or gate arrays, off-the-shelf semiconductors such as logic chips, transistors, or other discrete components. A processing unit may also be implemented in programmable hardware devices such as field programmable gate arrays, programmable array logic, programmable logic devices, or the like. A processing unit may also be configured to execute program instructions or computer instructions from any suitable form of non-transitory computer-readable media to perform specified operations.

Storage subsystem 212 is usable by processing unit 250 (e.g., to store instructions executable by and data used by processing unit 250). Storage subsystem 212 may be implemented by any suitable type of physical memory media, including hard disk storage, floppy disk storage, removable disk storage, flash memory, random access memory (RAM-SRAM, EDO RAM, SDRAM, DDR SDRAM, RDRAM, etc.), ROM (PROM, EEPROM, etc.), and so on. Storage subsystem 212 may consist solely of volatile memory in some embodiments. Storage subsystem 212 may store program instructions executable by computing device 210 using processing unit 250, including program instructions executable to cause computing device 210 to implement the various techniques disclosed herein.

I/O interface 230 may represent one or more interfaces and may be any of various types of interfaces configured to couple to and communicate with other devices, according to various embodiments. In some embodiments, I/O interface 230 is a bridge chip from a front-side to one or more back-side buses. I/O interface 230 may be coupled to one or more I/O devices 240 via one or more corresponding buses or other interfaces. Examples of I/O devices include storage devices (hard disk, optical drive, removable flash drive, storage array, SAN, or an associated controller), network interface devices, user interface devices or other devices (e.g., graphics, sound, etc.).

This specification includes references to “one embodiment,” “some embodiments,” or “an embodiment.” The appearances of these phrases do not necessarily refer to the same embodiment. Particular features, structures, or characteristics may be combined in any suitable manner consistent with this disclosure.

As used herein, the term “based on” is used to describe one or more factors that affect a determination. This term does not foreclose the possibility that additional factors may affect the determination. That is, a determination may be solely based on specified factors or based on the specified factors as well as other, unspecified factors. Consider the phrase “determine A based on B.” This phrase specifies that B is a factor is used to determine A or that affects the determination of A. This phrase does not foreclose that the determination of A may also be based on some other factor, such as C. This phrase is also intended to cover an embodiment in which A is determined based solely on B. As used herein, the phrase “based on” is synonymous with the phrase “based at least in part on.”

Within this disclosure, different entities (which may variously be referred to as “units,” “circuits,” other components, etc.) may be described or claimed as “configured” to perform one or more tasks or operations. This formulation—[entity] configured to [perform one or more tasks]—is used herein to refer to structure (i.e., something physical, such as an electronic circuit). More specifically, this formulation is used to indicate that this structure is arranged to perform the one or more tasks during operation. A structure can be said to be “configured to” perform some task even if the structure is not currently being operated. A “computing system configured to receive a request from a client” is intended to cover, for example, a system that has circuitry that performs this function during operation, even if the circuitry in question is not currently being used (e.g., a power supply is not connected to it). Thus, an entity described or recited as “configured to” perform some task refers to something physical, such as a device, circuit, memory storing program instructions executable to implement the task, etc. This phrase is not used herein to refer to something intangible.

The term “configured to” is not intended to mean “configurable to.” An unprogrammed FPGA, for example, would not be considered to be “configured to” perform some specific function, although it may be “configurable to” perform that function, and may, after programming, be “configured to” perform that function.

Reciting in the appended claims that a structure is “configured to” perform one or more tasks is expressly intended not to invoke 35 U.S.C. §112(f) for that claim element. Accordingly, none of the claims in this application as filed are intended to be interpreted as having means-plus-function elements. Should Applicant wish to invoke Section 112(f) during prosecution, it will recite claim elements using the “means for [performing a function]” construct.

It is to be understood the present disclosure is not limited to particular devices or methods, which may, of course, vary. It is also to be understood that the terminology used herein is for the purpose of describing particular embodiments only, and is not intended to be limiting. As used herein, the singular forms “a”, “an”, and “the” include singular and plural referents unless the content clearly dictates otherwise. Furthermore, the word “may” is used throughout this application in a permissive sense (i.e., having the potential to, being able to), not in a mandatory sense (i.e., must). The term “include,” and derivations thereof, mean “including, but not limited to.” The term “coupled” means directly or indirectly connected.

Although specific embodiments have been described above, these embodiments are not intended to limit the scope of the present disclosure, even where only a single embodiment is described with respect to a particular feature. Examples of features provided in the disclosure are intended to be illustrative rather than restrictive unless stated otherwise. The above description is intended to cover such alternatives, modifications, and equivalents as would be apparent to a person skilled in the art having the benefit of this disclosure. Although various advantages of this disclosure have been described, any particular embodiment may incorporate some, all, or even none of such advantages.

The scope of the present disclosure includes any feature or combination of features disclosed herein (either explicitly or implicitly), or any generalization thereof, whether or not it mitigates any or all of the problems addressed herein. Accordingly, new claims may be formulated during prosecution of this application (or an application claiming priority thereto) to any such combination of features. In particular, with reference to the appended claims, features from dependent claims may be combined with those of the independent claims and features from respective independent claims may be combined in any appropriate manner and not merely in the specific combinations enumerated in the appended claims.

What is claimed is:

1. A method, comprising:
a server computing system providing an application programming interface (API) to a client computing system, wherein the API is operable to allow insertion of objects into a database at the server computing system, and wherein the API permits arbitrary hierarchical relationships among the objects to be expressed via user-specified code;
the server computing system receiving, via the API, a request from the client computing system to insert a plurality of objects into the database;
the server computing system receiving, via the API, user-specified code associated with the plurality of objects, wherein the user-specified code includes a set of hierarchical relationships among the plurality of objects; and
the server computing system inserting the plurality of objects into the database, wherein the inserted plurality of objects includes the set of hierarchical relationships.

2. The method of claim 1, wherein the database is a multi-tenant database.

3. The method of claim 1, wherein the server computing system includes a plurality of individual servers.

4. The method of claim 1, wherein the request from the client computing system to insert the plurality of objects into the database specifies the objects via JavaScript Object Notation (JSON).

5. The method of claim 1, wherein the request from the client computing system to insert the plurality of objects into the database and the user-specified code associated with the plurality of objects are contained within a single transaction.

6. The method of claim 1, wherein the set of hierarchical relationships among the plurality of objects are defined with respect to a data model.

7. The method of claim 6, wherein the user-specified code associated with the plurality of objects is defined with respect to a meta-model different from the data model.

8. The method of claim 7, further comprising the server computing system inferring the set of hierarchical relationships based on the user-specified code.

9. A non-transitory, computer-readable medium having stored thereon computer instructions capable of causing operations comprising:
providing an application programming interface (API) to a client computing system, wherein the API is operable to allow insertion of objects into a database, and wherein the API permits arbitrary hierarchical relationships among the objects to be expressed via user-specified code;
receiving, via the API, a request from the client computing system to insert a plurality of objects into the database;
receiving, via the API, user-specified code associated with the plurality of objects, wherein the user-specified code includes a set of hierarchical relationships among the plurality of objects;
determining an insertion order for the plurality of objects;
performing a preliminary insertion of the plurality of objects into the database based on the determined insertion order, wherein the inserted plurality of objects includes the set of hierarchical relationships; and
in response to a determination that no errors have been detected, committing the preliminary insertion.

10. The medium of claim 9, wherein the operations further comprise: in response to a determination that at least one error has been detected, rolling back the preliminary insertion.

11. The medium of claim 9, wherein determining an insertion order for the plurality of objects includes performing a topological sort of the plurality of objects.

12. The medium of claim 9, wherein determining an insertion order for the plurality of objects includes determining that the set of hierarchical relationships does not include a cyclical dependency.

13. The medium of claim 9, wherein the operations further comprise:
determining a trigger to be executed on at least one of the inserted plurality of objects; and
executing the trigger on the at least one of the inserted plurality of objects.

14. The medium of claim 13, wherein the operations further comprise:
detecting an error based on the executed trigger; and
in response to the detected error, rolling back the preliminary insertion.

15. The medium of claim 9, wherein the receiving the request to insert the plurality of objects into the database and the receiving the user-specified code comprise a single round trip between the client computing system and the API.

16. The medium of claim 9, wherein the receiving the request to insert the plurality of objects into the database and the receiving the user-specified code comprise two separate round trips between the client computing system and the API.

17. The medium of claim 9, wherein the receiving the request to insert the plurality of objects into the database and the receiving the user-specified code comprise at most two separate transactions.

18. The medium of claim 9, wherein the operations further comprise: inferring the set of hierarchical relationships based on the user-specified code.

19. A non-transitory, computer-readable medium having stored thereon computer instructions configured to cause a computing system to perform operations comprising:
accessing a server computing system via an application programming interface (API) operable to allow insertion of objects into a database at the server computing system, wherein the API permits arbitrary hierarchical relationships among the objects to be expressed via user-specified code;
transmitting, via the API, a request to the server computing system to insert a plurality of objects into the database; and
transmitting, via the API, user-specified code associated with the plurality of objects to the server computing system, wherein the user-specified code defines a set of hierarchical relationships among the plurality of objects;
wherein the server computing system is operable to insert the plurality of objects into the database, and wherein the inserted plurality of objects includes the set of hierarchical relationships.

20. The medium of claim 19, wherein the operations further comprise exporting the plurality of objects from a different database prior to transmitting the request to insert the plurality of objects into the database.
